(19) United States
(12) Patent Application Publication
(10) Pub. No.: US 2024/0128444 A1
(43) Pub. Date: Apr. 18, 2024

(54) CATHODES FOR LITHIUM-SULFUR BATTERIES WITH NANOCATALYSTS

(71) Applicant: The Florida International University Board of Trustees, Miami, FL (US)

(72) Inventors: Bilal M. El-Zahab, Miami, FL (US); Dambar Hamal, Miami, FL (US); Osama Awadallah, Miami, FL (US); Georgina Jahan, Miami, FL (US); Archana Loganathan, Miami, FL (US); Ana Claus, Miami, FL (US)

(21) Appl. No.: 18/484,598

(22) Filed: Oct. 11, 2023

Related U.S. Application Data
(60) Provisional application No. 63/379,276, filed on Oct. 12, 2022.

(51) Int. Cl. H01M 4/36; H01M 4/04; H01M 4/62; H01M 10/052

(52) U.S. Cl. CPC H01M 4/366; H01M 4/0416; H01M 4/622; H01M 4/625; H01M 10/052; H01M 2004/028

(57) ABSTRACT

Lithium-sulfur battery cathodes with a graded structure are provided and can include an actively electro-catalyzing and polysulfide-trapping system to improve sulfur utilization and capacity retention, as well as methods of fabricating the same and methods of using the same. The graded structure Li—S cathode can be prepared using economic and scalable synthesis and coating methods.

### CROSS-REFERENCE TO RELATED APPLICATION

This application claims the benefit of U.S. Provisional Application Ser. No. 63/379,276, filed Oct. 12, 2022, the disclosure of which is hereby incorporated by reference in its entirety, including all figures, tables, and drawings.

### BACKGROUND

Lithium-sulfur (Li—S) batteries conversion-type electrochemical systems that promise a high energy density for electric vehicles (EVs) because of the exceptionally high capacity of lithium metal (3860 milliamp-hours per gram (mAh/g)) and sulfur (1675 mAh/g), especially with the active material, sulfur (S₈), being naturally abundant, stable, and very cheap. The theoretical energy density of a Li—S battery at the cell level is 2600 Watt-hours per kilogram (Wh/kg) for its complete electrochemical reaction. However, Li—S batteries are negatively affected by the slow redox electrochemistry of sulfur due to their extremely low electronic conductivity (1×10⁻³⁰ Siemens per centimeter (S/cm)) along with the volume expansion (80%) and dissolution of lithium polysulfides in the electrolyte. The long-chain lithium polysulfide solubility in liquid electrolytes leads to inefficient utilization of sulfur, especially at higher sulfur loadings. Due to the above-mentioned issues, the battery capacity quickly fades in the initial charge/discharge cycles.

In order to attempt to improve the capacity of the sulfur cathode, research efforts have been pursued to solve the Li—S battery chemistry via anode protection, new electrolyte formulation, separator design, and sulfur cathode architecture. Electrochemical reduction of sulfur in Li—S battery chemistry requires a catalyst with high electronic conductivity. Catalysts have shown improvement in cycle stability of Li—S batteries, but catalyst incorporation in conversion reaction battery systems often leads to unintended and/or undesirable side reactions.

### BRIEF SUMMARY

In view of the above-mentioned issues, there is a need in the art for electrocatalyst use in lithium-sulfur (Li—S) batteries to be implemented more effectively (e.g., by designing the Li—S cathode architecture to optimize catalyst spatial location in the cathode and further improve sulfur utilization and cycle stability). Embodiments of the subject invention provide novel and advantageous Li—S batteries with a graded structure as positive electrode (i.e., cathode) that includes an actively electro-catalyzing and polysulfide-trapping system to improve sulfur utilization and capacity retention for application in Li—S batteries, as well as methods of fabricating the same and methods of using the same. The graded structure Li—S cathode can be prepared using economic and scalable synthesis and coating methods. Electrochemical performance results show that the graded structure Li—S cathode provides improved sulfur utilization and cycle stability in comparison to Li—S batteries without the graded structure Li—S cathode. The cathode without the graded structure can be referred to herein as a “baseline cathode” or “baseline structure”. The graded structure Li—S cathode with nanocatalyst shows an average of 20% increase in initial sulfur utilization and more than 30% improvement in cell capacity retention over 200 cycles compared to baseline cathodes.

In an embodiment, a positive electrode for a Li—S battery can comprise: sulfur-rich layers comprising at least one first nanocatalyst; and electro-catalyzing and polysulfide-trapping layers comprising at least one second nanocatalyst. The sulfur-rich layers can be merged and interlocked together with the electro-catalyzing and polysulfide trapping layers in a graded structure. The at least one first nanocatalyst can include at least one nanocatalyst in common with the at least one second nanocatalyst. The at least one first nanocatalyst can comprise at least one metal (e.g., at least one transition metal such as at least one of nickel (Ni), cobalt (Co), platinum (Pt), palladium (Pd) ruthenium (Ru), iridium (Jr), rhodium (Rh), silver (Ag), and gold (Au)) and/or an oxide, sulfide, fluoride, and/or carbide of at least one metal (e.g., at least one transition metal such as at least one of Ni, Co, Pt, Pd, Ru, Jr, Rh, Ag, and Au). The at least one second nanocatalyst can comprise at least one metal (e.g., at least one transition metal such as at least one of Ni, Co, Pt, Pd, Ru, Ir, Rh, Ag, and Au) and/or an oxide, sulfide, fluoride, and/or carbide of at least one metal (e.g., at least one transition metal such as at least one of Ni, Co, Pt, Pd, Ru, Jr, Rh, Ag, and Au). The positive electrode can have sulfur distributed uniformly (or substantially uniformly (i.e., with a concentration that doesn't differ by more than 5% at any point compared to every other point)) across the graded structure. The positive electrode can alternatively have sulfur distributed in a gradient fashion across the graded structure. The sulfur-rich layers can comprise conductive carbon (e.g., carbon nanotubes (CNTs), graphene, fullerene, graphitized carbon, Super P conductive carbon, acetylene black, carbon fiber, or carbon nanofiber). The electro-catalyzing and polysulfide-trapping layers can comprise conductive carbon (e.g., CNTs, graphene, fullerene, graphitized carbon, Super P conductive carbon, acetylene black, carbon fiber, or carbon nanofiber). The positive electrode can optionally further comprise a binder (e.g., polyvinylidene fluoride (PVDF), polyacrylic acid (PAA)). The positive electrode can alternatively be binder-free (i.e., with no binder present at all in the positive electrode).

In another embodiment, an Li—S battery can comprise: a current collector (e.g., aluminum (Al), such as Al foil); a positive electrode as disclosed herein disposed on (and optionally in direct physical contact with) the current collector; a separator disposed on (and optionally in direct physical contact with) a first surface of the positive electrode, the first surface of the positive electrode being opposite from a second surface of the positive electrode on which the current collector is disposed (and with which the current collector is optionally in direct physical contact); and a lithium anode on (and optionally in direct physical contact with) the separator (the anode can be on an opposite side of the separator from the positive electrode). The Li—S battery can further comprise: a first spacer below the current collector; a spring below the first spacer and/or the current collector; a bottom cap below the spring, the first spacer, and/or the current collector; a second spacer on the lithium anode; and/or a top cap on the second spacer and/or the lithium anode.

In another embodiment, a method of fabricating a positive electrode can comprise: preparing a composite mixture of a polymeric binder (e.g., cellulose acetate, polyacrylic acid, polyvinylidene fluoride) and a carbon-containing material, the carbon-containing material comprising conductive carbon (e.g., CNTs, Super P conductive carbon, acetylene black, carbon fiber, or carbon nanofiber) and a metal nanocatalyst present at a predetermined weight percentage; adding a first organic solvent (e.g., acetone, tetrahydrofuran (THF)) to the composite mixture to give a first solution; performing vacuum filtration on the first solvent to give a graded porous film; and drying the graded porous film to give the positive electrode. The positive electrode can comprise sulfur-rich layers merged and interlocked together with electro-catalyzing and polysulfide trapping layers in a graded structure. The metal nanocatalyst can comprise at least one metal (e.g., at least one transition metal such as at least one of Ni, Co, Pt, and Pd). The predetermined weight percentage can be in a range of from 0.1 wt % to 10 wt % (e.g., from 1 wt % to 5 wt %). The carbon-containing material can further comprise sulfur. The preparing of the composite mixture can comprise: dissolving the polymeric binder in a second organic solvent (e.g., acetone, THF) to give a second solution; gradually adding the second solution to a dry powder mixture of the carbon-containing material to give a third solution; and grinding the third solution to evaporate the second organic solvent and give the composite mixture. The drying of the graded porous film can comprise drying the graded porous film at a temperature in a range of, for example, from 40° C. to 100° C. (e.g., from 40° C. to 60° C.) for a period of time in a range of, for example, from 10 hours to 15 hours. The method can further comprise preparing the carbon-containing material prior to preparing the composite mixture. The preparing of the carbon-containing material can comprise: preparing a first mixture of the conductive carbon and a salt (e.g., a nitrate salt) of the metal nanocatalyst (e.g., at a weight ratio in a range of, for example, 99:1 to 95:5 of conductive carbon: pure metal nanocatalyst); adding water (e.g., deionized water) to the first mixture to give a second mixture; bath sonicating the second mixture; drying the second mixture after the bath sonicating of the second mixture; grinding the second mixture after the drying of the second mixture; oxidizing the second mixture in a furnace after grinding the second mixture to give an oxidized second mixture; allowing the oxidized second mixture to cool down (e.g., naturally cool down to room temperature or about room temperature); reducing the oxidized second mixture, after allowing the oxidized second mixture to cool down, by providing a gas flow comprising hydrogen to the oxidized second mixture to provide a reduced second mixture; allowing the reduced second mixture to cool down (e.g., naturally cool down to room temperature or about room temperature); and grinding the reduced second mixture, after allowing the second mixture to cool down, to give a dry powder mixture of the carbon-containing material. The oxidizing of the second mixture can comprise oxidizing the second mixture in the furnace at a temperature of, for example, 350° C. or about 350° C. for a period of time of, for example, 2 hours or about 2 hours. The reducing of the second mixture can comprise providing the gas flow at a temperature of, for example, 400° C. or about 400° C. for a period of time of, for example, 2 hours or about 2 hours. The gas flow can further comprise argon (e.g., 5% hydrogen/argon). The positive electrode can have sulfur distributed uniformly (or substantially uniformly) across the graded structure. The sulfur-rich layers can comprise conductive carbon (e.g., CNTs, Super P conductive carbon, acetylene black, carbon fiber, or carbon nanofiber). The electro-catalyzing and polysulfide-trapping layers can comprise conductive carbon (e.g., CNTs, Super P conductive carbon, acetylene black, carbon fiber, or carbon nanofiber). The positive electrode can further comprise a binder (e.g., PVDF, PAA). The positive electrode can alternatively be binder-free (i.e., with no binder present at all in the positive electrode).

In another embodiment, a method of fabricating an Li—S battery can comprise: fabricating a positive electrode using a method as disclosed herein; disposing the positive electrode on (and optionally in direct physical contact with) a current collector (e.g., Al, such as Al foil); disposing the positive electrode on (and optionally in direct physical contact with) a separator; and disposing a lithium anode on (and optionally in direct physical contact with) the separator. The separator can be on (and optionally in direct physical contact with) a first surface of the positive electrode that is opposite from a second surface of the positive electrode on which the current collector is disposed (and with which the current collector is optionally in direct physical contact). The anode can be on an opposite side of the separator from the positive electrode. The method can further comprise: disposing a first spacer below the current collector; disposing a spring below the first spacer and/or the current collector; disposing a bottom cap below the spring, the first spacer, and/or the current collector; disposing a second spacer on the lithium anode; and/or disposing a top cap on the second spacer and/or the lithium anode.

### BRIEF DESCRIPTION OF DRAWINGS

FIG. 1 shows a plot of heat flow (in Watts per gram (W/g)) and weight (in percentage (%)) both versus temperature (in degrees Celsius (° C.)), showing the thermogravimetric analysis (TGA) (heat flow curve) and differential scanning calorimetry (DSC) (weight curve) of a sulfur-carbon composite. The dashed curve is for the heat flow, and the solid curve is for the weight.

FIG. 2 shows a scanning electron microscope (SEM) image of a cross-section of a platinum (Pt)-containing graded structure lithium-sulfur (Li—S) cathode (having a first configuration) coated on a polypropylene separator, according to an embodiment of the subject invention. The elemental analysis line scan showing sulfur content across the thickness of the cathode is provided at the right-hand side of the figure.

FIG. 3(a) shows a high magnification SEM surface image of a Pt-containing graded structure Li—S cathode, according to an embodiment of the subject invention. The scale bar is 100 nanometers (nm).

FIG. 3(b) shows a high magnification transmission electron microscope (TEM) image showing a carbon surface with catalyst particles decorating the carbon surface. The scale bar is 100 nm.

FIG. 4 shows a plot of discharge capacity (in milliamp-hours per gram (mAh/g)) versus cycle number, showing the electrochemical performance of a graded structure Li—S cathode (having a first configuration) according to an embodiment of the subject invention (labeled in the figure as “new structure cathode”), having different metal catalysts and as compared to a baseline cathode (i.e., a cathode not having a graded structure). The solid curve with the highest capacity value at cycle number 2 is for graded structure cathode with a Pt catalyst; the dashed curve with the second-highest capacity value at cycle number 2 is for graded structure cathode with a nickel (Ni) catalyst; the dashed curve with the third-highest capacity value at cycle number 2 is for graded structure cathode with a palladium (Pd) catalyst; the dotted curve with the fourth-highest capacity value at cycle number 2 is for graded structure cathode with a cobalt (Co) catalyst; and the solid curve with the lowest capacity value at cycle number 2 is for the baseline cathode.

FIG. 5(a) shows a plot of discharge capacity (in mAh/g) versus cycle number, showing the electrochemical performance of a Pt-containing graded structure Li—S cathode (having a first configuration) according to an embodiment of the subject invention (labeled in the figure as “new structure cathode”) and a baseline cathode. Both cathodes had a sulfur loading of 2.50 milligrams per square centimeter (mg/cm²), and the testing was performed at +0.1C/−0.2C rates and 1.8 Volts (V)-3.0 V. The square data points with the higher discharge capacity values are for the graded structure cathode, and the circle data points with the lower discharge capacity values are for the baseline cathode.

FIG. 5(b) shows a plot of discharge capacity (in mAh/g) versus cycle number, showing the electrochemical performance of a Pt-containing graded structure Li—S cathode (having a first configuration) according to an embodiment of the subject invention (labeled in the figure as “new structure cathode”) and a baseline cathode. Both cathodes had a sulfur loading of 5.0 mg/cm², and the testing was performed at +0.16C/−0.2C rates and 1.8 V-3.0 V. The square data points with the higher discharge capacity values are for the graded structure cathode, and the circle data points with the lower discharge capacity values are for the baseline cathode.

FIG. 5(c) shows a plot of discharge capacity (in mAh/g) versus cycle number, showing the electrochemical performance of a Pt-containing graded structure Li—S cathode (having a first configuration) according to an embodiment of the subject invention (labeled in the figure as “new structure cathode”) and a baseline cathode. Both cathodes had a sulfur loading of 3.4 mg/cm², and the testing was performed at higher C-rates (+0.33C/−0.5C rates) and 1.8 V-3.0 V. The square data points with the generally higher discharge capacity values are for the graded structure cathode, and the circle data points with the generally lower discharge capacity values are for the baseline cathode.

FIG. 6 shows a plot of discharge capacity (in mAh/g) versus C-rates (in milliamps per square centimeter per gram (mA/cm²/g s)), showing the electrochemical performance of a Pt-containing graded structure Li—S cathode (having a first configuration) according to an embodiment of the subject invention (labeled in the figure as “new structure cathode”) and a baseline cathode. Both cathodes had a sulfur loading of 3.85 mg/cm², and the testing was performed at 1.8 V-3.0 V. The square data points with the generally higher discharge capacity values are for the graded structure cathode, and the circle data points with the generally lower discharge capacity values are for the baseline cathode.

FIG. 7 shows a plot of voltage (in V) versus capacity (in mAh/g), showing the first cycle voltage profile of a Pt-containing graded structure Li—S cathode (having a first configuration) according to an embodiment of the subject invention (labeled in the figure as “new structure cathode”) and a baseline cathode. The solid curves are for the graded structure cathode, and the dashed curves are for the baseline cathode.

FIG. 8 shows a plot of current (in Amps (A)) versus voltage (in V, versus Li/Li⁺), showing the cyclic voltammetry (CV) plots of a Pt-containing graded structure Li—S cathode (having a first configuration) according to an embodiment of the subject invention (labeled in the figure as “new structure cathode”) and a baseline cathode. The solid curves are for the graded structure cathode, and the dashed curves are for the baseline cathode.

FIG. 9 shows a plot of discharge capacity (in mAh/g) versus cycle number, showing the electrochemical performance of a graded structure Li—S cathode (having a second configuration) according to an embodiment of the subject invention (labeled in the figure as “new structure cathode”), having different metal catalysts and as compared to a baseline cathode. The solid curve with the highest capacity value at cycle number 2 is for graded structure cathode with a Pt/Pt catalyst; the dashed curve with the second-highest capacity value at cycle number 2 is for graded structure cathode with a Ni/Pt catalyst; the dotted curve with the third-highest capacity value at cycle number 2 is for graded structure cathode with a Co/Pt catalyst; the dashed curve with the fourth-highest capacity value at cycle number 2 is for graded structure cathode with a Pd/Pt catalyst; and the solid curve with the lowest capacity value at cycle number 2 is for the baseline cathode.

FIG. 10(a) shows an SEM image of nanocatalysts loaded in multi-walled carbon nanotubes (MWCNTs). The scale bar is 20 nm.

FIG. 10(b) shows a plot of cell capacity (in mAh/g for sulfur) versus cycle number for nanocatalyst-containing cathodes according to an embodiment of the subject invention, compared to baseline cathodes (or “control cathodes”). The data points having the higher cell capacity values are for the nanocatalyst-containing cathodes, and the data points having the lower cell capacity values are for the control cathodes.

FIG. 11 shows a table showing initial and cycle 10 discharge capacity (in mAh/g) of a graded structure Li—S cathode (having a first configuration) according to an embodiment of the subject invention (labeled in the figure as “new structure cathode”), compared to a baseline cathode.

FIG. 12 shows a table showing the rate capability of a Pt-containing graded structure Li—S cathode (having a first configuration) according to an embodiment of the subject invention (labeled in the figure as “new structure cathode”) and a baseline cathode.

FIG. 13 shows a table showing initial and cycle 10 discharge capacity (in mAh/g) of a graded structure Li—S cathode (having a second configuration) according to an embodiment of the subject invention (labeled in the figure as “new structure cathode”), compared to a baseline cathode.

### DETAILED DESCRIPTION

Embodiments of the subject invention provide novel and advantageous lithium-sulfur (Li—S) batteries with a graded structure as positive electrode (i.e., cathode) that includes an actively electro-catalyzing and polysulfide-trapping system to improve sulfur utilization and capacity retention for application in Li—S batteries, as well as methods of fabricating the same and methods of using the same. The graded structure Li—S cathode can be prepared using economic and scalable synthesis and coating methods. Electrochemical performance results show that the graded structure Li—S cathode provides improved sulfur utilization and cycle stability in comparison to Li—S batteries without the graded structure Li—S cathode. The cathode without the graded structure can be referred to herein as a “baseline cathode” or “baseline structure”. The graded structure Li—S cathode with nanocatalyst (which can also be referred to herein as “new structure cathode” or “new structure Li—S cathode”) shows an average of 20% increase in initial sulfur utilization and more than 30% improvement in cell capacity retention over 200 cycles compared to baseline cathodes.

The graded structure Li—S cathode is developed to maximize sulfur utilization and improve cycle stability in Li—S batteries through the effective spatial distribution of the metal catalyst. The new structure Li—S cathode comprises a sulfur-rich and conductive carbon mixture layer, which can include a binder (e.g., as discussed in Example 1 or Example 3) and a buffer layer that forms the actively electro-catalyzing and polysulfide trapping system. The thickness of the layers can be tuned depending on the sulfur loading.

The graded structure Li—S cathode can be prepared in a two-step process that includes coating a sulfur-rich layer (e.g., using the structure as prepared in Example 1 or Example 3) followed by a buffer layer that possesses both electronic conductivity and electrocatalytic activity. The layers can be applied sequentially either with the use of a binder or binder-free (i.e., with no binder used). For example, a sulfur-rich layer can be coated and dried on a current collector (e.g., on Al foil) followed by applying the buffer layer. The same layered structure can be implemented by coating the layers directly on the separator in reverse order in which the buffer layer is coated first followed by the sulfur-rich layer. Other sequential coating approaches of multiple stacks of the two layers can also be implemented. Upon drying, the final coating forms a mechanically interlocked tuned/graded porous structure.

In embodiments of the subject invention, interconnected electron conduction pathways can be established through the entire cathode. The new structure Li—S cathode maximizes sulfur utilization by confining higher degree polysulfide species (e.g., Li₂S₈ and Li₂S₆) within the cathode structure and effectively catalyzing them in a highly reversible process due to the spatial location of the catalyst. A cathode-current collector-separator configuration can include, e.g., a current collector (e.g., a metal foil such as an aluminum foil), the sulfur-rich and electro-catalyzing and polysulfide trapping layers (which can be merged and interlocked together to form the new structure cathode) disposed on the current collector, and a separator (e.g., a polypropylene separator) disposed on the sulfur-rich and electro-catalyzing and polysulfide trapping layers (i.e., disposed on the cathode). Sulfur can be distributed uniformly or substantially uniformly across the thickness of the cathode (e.g., across the sulfur-rich and electro-catalyzing and polysulfide trapping layers). Embodiments provide higher capacity retention rate over cycling and higher initial capacity and sulfur utilization compared to related art Li—S batteries.

A cathode can comprise elemental sulfur, conductive carbon (e.g., carbon nanotubes, Super P conductive carbon, acetylene black, carbon fiber, or carbon nanofiber), and a binder (e.g., polyvinylidene fluoride, polyacrylic acid). A structure can be prepared as described in Examples 1 and/or 3, and then a sulfur-rich layer can be coated on the structure. This can be followed by coating a buffer layer having both electronic conductivity and electrocatalytic activity on the structure and/or the sulfur-rich layer. For example, a sulfur-rich layer can be coated and dried on a current collector, followed by applying the buffer layer. The same layered structure can be implemented by coating the layers directly on a separator in reverse order in which the buffer layer is coated first followed by the sulfur-rich layer. Other sequential coating approaches of multiple stacks of the two layers can also be implemented. Upon drying, the final coating forms a mechanically interlocked tuned/graded porous structure for the cathode.

In an embodiment, a sulfur-conductive carbon composite can be synthesized as follows. Elemental sulfur and conductive carbon (e.g., carbon nanotubes such as multiwalled carbon nanotubes) can be combined (e.g., in a ratio of, for example, 7:3 by weight or in a range of from 7:6 by weight to 7:1 by weight including any subrange therewithin (including 2:1)) (e.g., by grinding such as with mortar and pestle at room temperature). The sulfur composite can optionally be further ball-milled (e.g., at 200-500 rpm for 4-8 h in an inert (e.g., argon) atmosphere) (composite:ball=1:10 or about 1:10 by weight is preferred, or a ratio of from 1:1 by weight to 1:20 by weight including any subrange therewithin). The composite sample (after combining or after optional ball-milling) can be placed inside an inert atmosphere (e.g., an argon glove box and put into a Teflon-lined stainless-steel autoclave). The inert atmosphere (e.g., the autoclave) can be heated (e.g., in an air oven) for sulfur melt-diffusion into the conductive carbon host (e.g., at 150-200° C. for 12-30 h). After naturally cooling down to room temperature, the sulfur composite can optionally be grinded (e.g., with mortar and pestle) and can be stored for several weeks for further use.

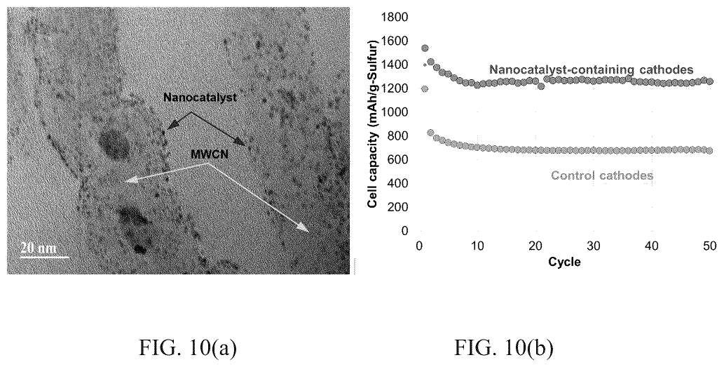

In embodiments, catalysts (e.g., nanocatalysts such as platinum group metal (PGM) nanocatalysts) can be implemented in Li—S cathodes using a process that is tailored to effectively improve catalyst dispersion and to provide controlled catalyst electrolyte contact. The nanocatalysts can be loaded in conductive carbon (e.g., carbon nanotubes) at variable low contents (e.g., 0.1 wt % to 5 wt %) and can be used in cathodes with sulfur loading up to 70 wt %. FIG. 10(a) shows an SEM image of nanocatalysts loaded in multi-walled carbon nanotubes (MWCNTs). The cathodes provide improved redox performance in Li—S batteries, lead to improved sulfur utilization, and maintain stable capacity even at high sulfur loadings of 4-5 mg/cm². Comparison of performance of nanocatalyst-containing batteries (i.e., having a new structure cathode) versus batteries with baseline cathodes (i.e., with no nanocatalyst) show that the nanocatalyst-containing batteries give improved first cycle capacity and stabilized capacity retention in the early cycling life of the battery, as seen in FIG. 10(b).

When ranges are used herein, combinations and subcombinations of ranges (e.g., subranges within the disclosed range), as well as specific embodiments therein, are intended to be explicitly included. When the term “about” is used herein, in conjunction with a numerical value, it is understood that the value can be in a range of 95% of the value to 105% of the value, i.e. the value can be +/−5% of the stated value. For example, “about 1 kg” means from 0.95 kg to 1.05 kg.

A greater understanding of the embodiments of the subject invention and of their many advantages may be had from the following examples, given by way of illustration. The following examples are illustrative of some of the methods, applications, embodiments, and variants of the present invention. They are, of course, not to be considered as limiting the invention. Numerous changes and modifications can be made with respect to embodiments of the invention.

### Materials and Methods

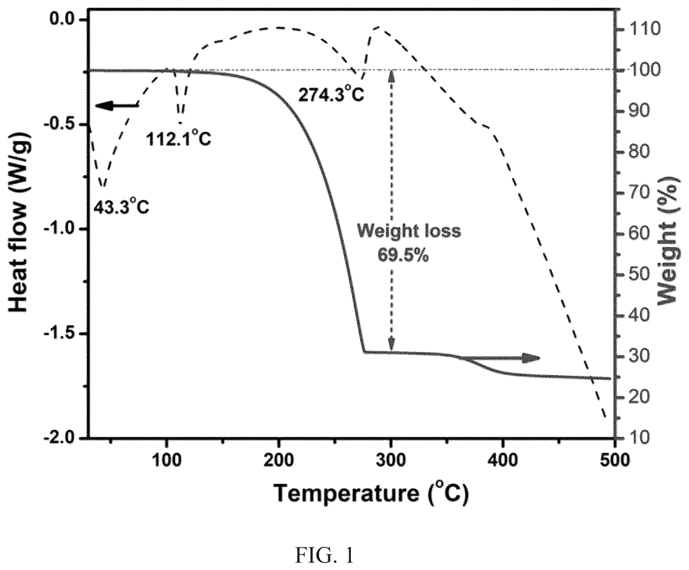

The cathodes comprised elemental sulfur, conductive carbon (that can be with or without metal catalyst) (e.g., carbon nanotubes (CNT), Super P conductive carbon (SP), acetylene black (AB), or carbon fiber (CF)), and a binder (e.g., polyvinylidene fluoride (PVDF), polyacrylic acid (PAA)). For example, a sulfur-conductive carbon composite is synthesized as follows. Elemental sulfur and multiwalled carbon nanotube in the ratio of 7:3 by weight were grinded with mortar and pestle at room temperature. The sulfur composite was further ball milled at 200-500 revolutions per minute (rpm) for 4-8 hours (h) in an argon atmosphere (composite:ball=1:10 by weight is preferred). The milled composite sample was taken inside an argon glove box and put into a Teflon-lined stainless-steel autoclave. The autoclave was taken outside, placed inside the air oven, and heated for sulfur melt-diffusion into the carbon nanotube host at 150-200° C. for 12-30 h. After naturally cooling down to room temperature, the sulfur composite was grinded with mortar and pestle and can be stored for several weeks for further use. FIG. 1 shows the thermogravimetric analysis (TGA) plot of the prepared sulfur-CNT composite. The TGA data indicates a total sulfur weight loss of 69.5% at 274° C. upon heating the sample to 500° C. at a rate of 5° C./min under argon atmosphere. The TGA results closely match the initial sulfur content in the sulfur-CNT composite. The electrolyte was prepared by dissolving 1 molar (M) lithium bis(trifluoro sulfonyl)imide (LiTFSI) and 0.1 M of anhydrous lithium nitrate (LiNO₃) in dioxolane (DOL) and dimethoxyethane (DME) at a ratio of 1:1 by volume inside the argon-filled glove box. The pre-cut lithium discs were soaked in the electrolyte before cell assembly to remove any trace moisture present. Coin cells were assembled in an argon-filled glove box using the pre-soaked Li disc, a polypropylene separator (Celgard), and a sulfur cathode. An extra amount of electrolyte was added to the pre-soaked separator and placed on top of the lithium anode with a spacer and bottom cap underneath, followed by putting sulfur cathode, spacer, spring, and top cap in sequence. The cell assembly was crimped under 90 pounds per square inch (psi) pressure using an argon gas-driven coin cell crimper. Electrochemical charge-discharge profiles of coin cells were recorded using MTI and Abrin Instruments Battery Testers at different C-rates in the voltage window of 1.8 V-3.0 V. Gamry potentiostat 5000E was used to record the cyclic voltammetry (CV) measurements.

### Example 1: Preparation of Li—S Cathode (First Configuration)

A castable slurry was prepared by mixing the prepared sulfur-conductive carbon composite (e.g., S-CNT 7:3) with conductive carbon (e.g., SP) and binder (e.g., polyvinylidene fluoride (PVDF)) in a weight ratio of 9:0.5:0.5. The dry solid mixture was grinded with mortar and pestle at room temperature, vortexed, and then further grinded. Then, dissolved binder in organic solvent (e.g., N-Methyl-2-pyrrolidone (NMP)) was added to the solid mixture. After the addition of the binder solution, the whole mixture was grinded with mortar and pestle, followed by adding a mixed solvent solution (e.g., DMF: Ethanol: NMP=1:1:1) and grinding. Then, small amounts of pure NMP were added in sequence to control the rheological property of the cathode slurry. A battery-grade aluminum (Al) foil was used as a current collector on which a certain amount of slurry was added, and doctor blade coated. The coated foil was directly dried in an oven at 60° C. for 6-12 h in air. After naturally cooling down, the coatings were vacuum dried in the same oven for 1-2 h and cathode discs were punched out with sulfur loadings in the range of 2.0-5.0 milligrams per square centimeter (mg/cm²). The cathode prepared in this example is referred to as first configuration.

### Example 2: Preparation of the Actively Electro-Catalyzing and Polysulfide Trapping System

The electro-catalyzing and polysulfide trapping system is an integral part of the Li—S cathode according to embodiments of the subject invention. The system comprises a conductive carbon material with a high aspect ratio (e.g., CNT, CF, or carbon nanofiber (CNF)) and an electrochemically active catalyst that is preferably a transition metal (e.g., Ni, Co, Pt, Pd, etc.). For example, a mixture of CNT and catalytic metal salt (e.g., a nitrate salt, such as palladium nitrate or platinum nitrate) with a weight ratio in a range of, for example, 99:1 to 95:5 of CNT: pure metal catalyst was weighed and placed in a glass beaker. The mixture was stirred, and extra deionized (DI) water was added to make a completely soaked and wetted CNT viscous slurry. Then, the beaker was bath sonicated for 10-30 minutes and stirred again. Next, the mixture was dried on a hotplate at a temperature in a range of 100° C.-120° C. overnight. The dried CNT: metal salt was gently grinded with mortar and pestle. Two quartz glass boats were filled with dried CNT:metal salt mixture and oxidized at 350° C. for 2 h in a tube furnace in air. After naturally cooling down, the oxidized metal on CNT was further reduced with 5% hydrogen/argon gas flow at 400° C. for 2 h. After naturally cooling down to room temperature, the reduced x % M-CNT (where M=Ni, Co, Pt, or Pd; x=1 weight percent (wt %) to 5 wt % of CNT) samples were grinded with mortar and pestle and stored in a dry powder form in a glass vial for further use.

### Example 3: Preparation of Li—S Cathode (Second Configuration)

A castable slurry was prepared by mixing the prepared sulfur-conductive carbon composite (e.g., S-x % M-CNT 7:3) (e.g., x=1 wt %, M=Pt) with conductive carbon (e.g., SP) and binder (e.g., PVDF) in a weight ratio of 9:0.5:0.5. The dry solid mixture was grinded with mortar and pestle at room temperature, vortexed, and then further grinded. Then, dissolved binder in organic solvent (e.g., NMP) was added to the solid mixture. After the addition of the binder solution, the whole mixture was grinded with mortar and pestle, followed by adding a mixed solvent solution (e.g., DMF:Ethanol:NMP=1:1:1) and grinding. Then, small amounts of pure NMP were added in sequence to control the rheological property of the cathode slurry. A battery-grade Al foil was used as a current collector on which a certain amount of slurry was added, and doctor blade coated. The coated foil was directly dried in an oven at 60° C. for 6-12 h in air. After naturally cooling down, the coatings were vacuum dried in the same oven for 1-2 h and cathode discs were punched out with sulfur loadings in the range of 2.0-5.0 mg/cm². The cathode prepared in this example is referred to as a second configuration.

### Example 4: Preparation of the Graded Structure Li—S Cathode

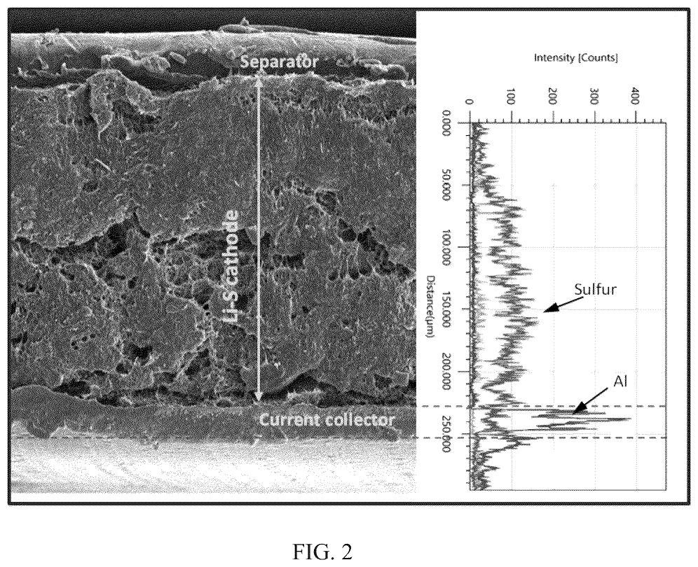

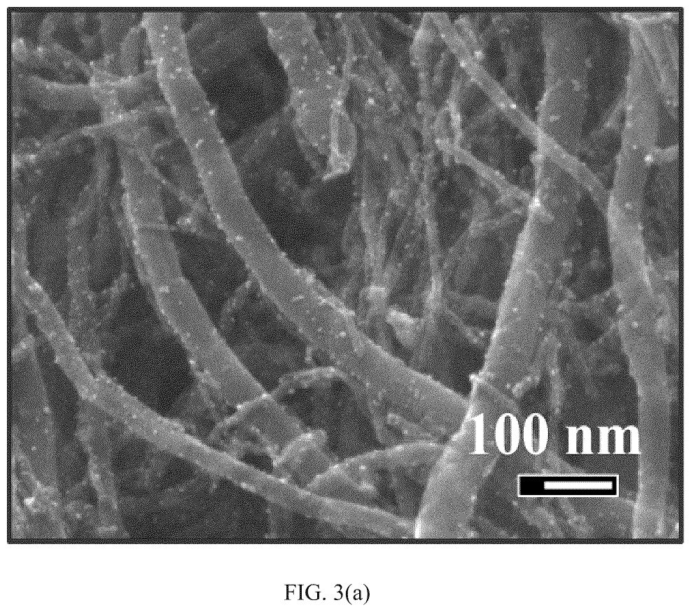

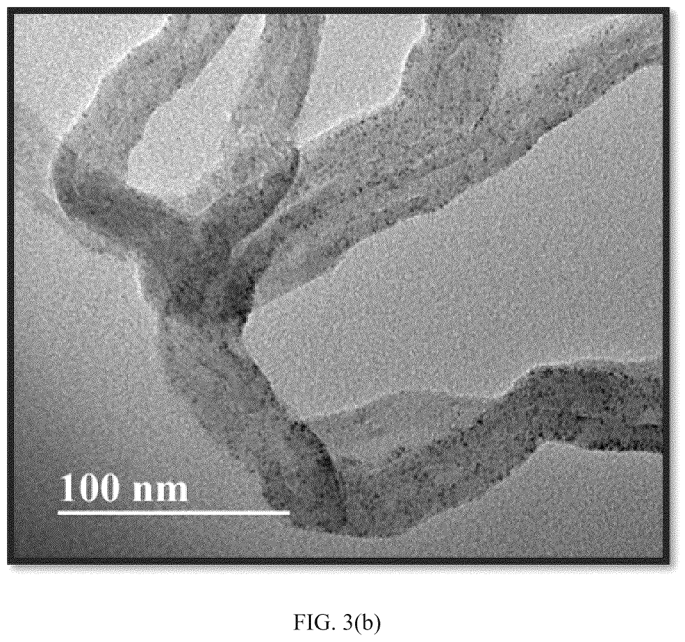

An example of the graded porous structure preparation on a polypropylene separator is detailed as follows. First, a composite mixture of x % M-CNT (x=1 wt % to 5 wt %) and cellulose acetate with a weight ratio of (7:3) was prepared. For example, cellulose acetate was dissolved into an organic solvent (e.g., acetone or tetrahydrofuran (THF)) by vortex mixing. Following that, the dissolved cellulose acetate solution was gradually added to the dry powder mixture of M-CNT (prepared as in Example 2) and grinded. During grinding acetone quickly evaporated and cellulose acetate remained with the x % M-CNT (x=1 wt % to 5 wt %) forming a composite mix that was collected and can be stored as dry powder. Second, organic solvent (e.g., acetone or THF) was added to the composite mix and mixed by vortex before bath sonication (10-20 minutes) and poured into a vacuum filtration setup containing a pre-cut polypropylene separator (Celgard) with an ordinary filter paper underneath. The filtration was immediately done using a high vacuum filtration setup connected to a vacuum filtration pump. The coated polypropylene separator was kept under a high vacuum for 1-2 h, removed by releasing the vacuum. Cellulose acetate makes the better dispersion of x % M-CNT (M=Ni, Co, Pt, or Pd x=1 wt % to 5 wt % of CNT) and plausibly directs a highly tortuous and graded porous architecture with good adhesion to the separator due to the faster filtration of solvent through the pores, leading to a very fast post-drying process. The prepared graded porous structure film was dried on a hot plate at 40-60° C. for 10-15 h and tested in Li—S batteries. Interconnected electron conduction pathways are established through the entire cathode. The new structure Li—S cathode maximizes sulfur utilization by confining higher degree polysulfide species (e.g., Li₂S₈ and Li₂S₆) within the cathode structure and effectively catalyzing them in a highly reversible process due to the spatial location of the catalyst. The scanning electron microscope (SEM) cross-sectional image in FIG. 2 shows the new structure cathode of a fully discharged full Li—S cell to 1.50 V. Referring to FIG. 2, the order from bottom to top is: Al foil (current collector); the sulfur-rich and electro-catalyzing and polysulfide trapping layers (both are merged and interlocked together to form the new structure cathode); and finally the separator is the top layer in the image. The energy dispersive x-ray spectroscopy (EDX) analysis using line scan detection method for a cross section cut of a fully discharged cathode shows a uniform sulfur distribution (sulfur represented by S in Li₂S) across the thickness. The high magnification SEM surface image in FIG. 3(a) shows the spatial distribution of the electrocatalyst (e.g., Pt metal catalyst particles appear as bright dots) on the conductive CNT surface of the new structure Li—S cathode. The high-resolution transmission electron microscope (TEM) image in FIG. 3(b) shows the metal catalyst as small dark particles decorating the CNT surface.

### Example 5: Using the New Structure Li—S Cathode in Li—S Batteries (First Configuration)

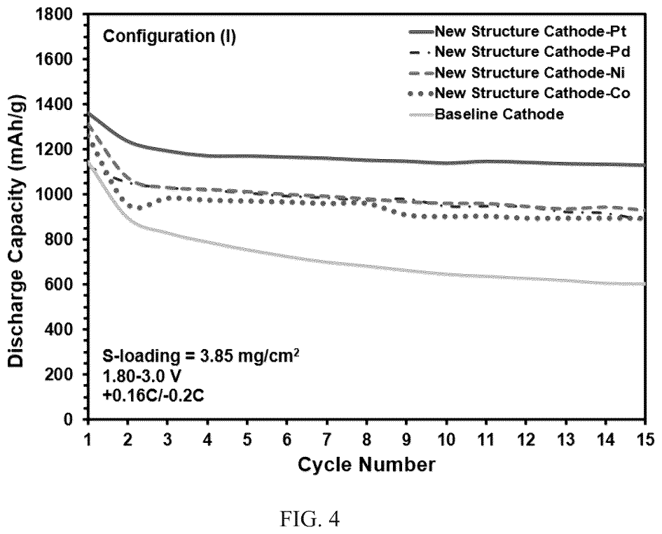

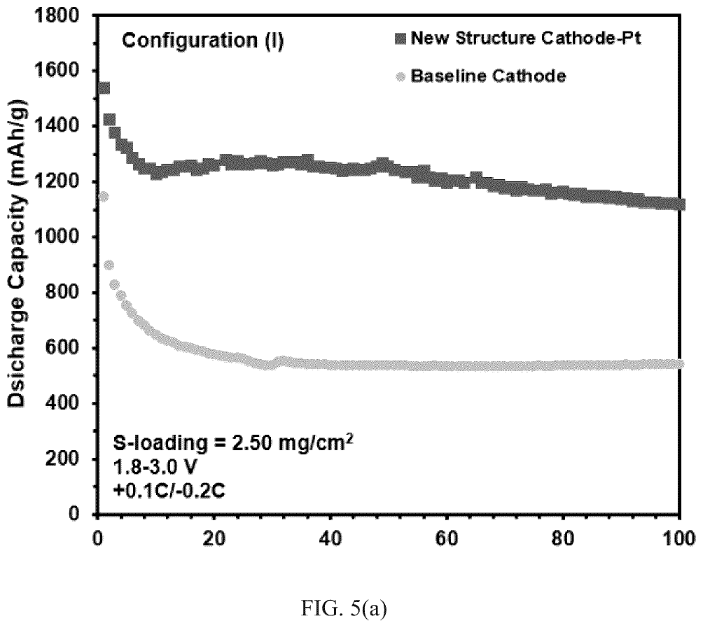

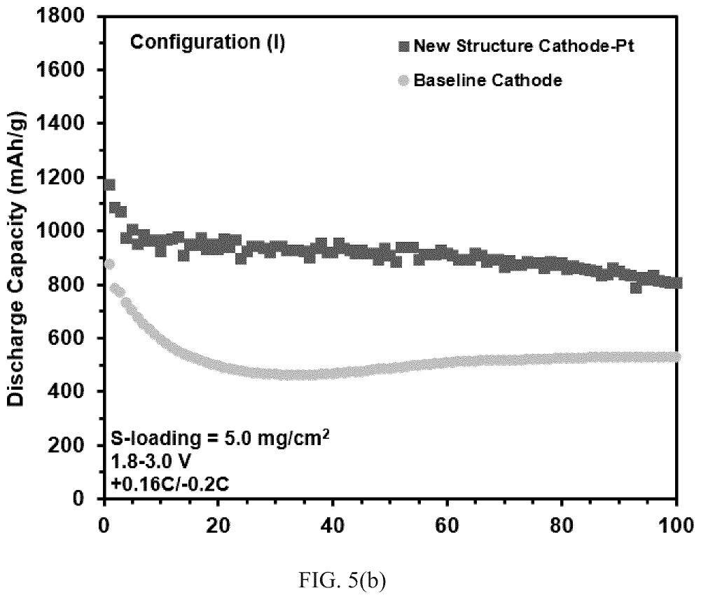

Coin cells (CR2032) were assembled in an argon-filled glove box using either a baseline structure or a new structure Li—S cathode (based on the first configuration) with a sulfur loading in the range of 2.5-5.0 mg/cm², a polypropylene separator (Celgard), and a pre-cut Li disc. Cells were crimped under pressure of 90 psi using an argon gas-driven coin cell crimper. Assembled cells were rested and tested at different C-rates (e.g., charge at C/10 and discharge at C/5, charge at C/6 and discharge at C/5, charge at C/3 and discharge at C/2) in the voltage window of 1.8 V-3.0 V. Cycling performance of cells (sulfur loading of 3.85 mg/cm²) tested using different nanocatalysts (Pt, Pd, Ni, and Co) is shown in FIG. 4. Referring to FIG. 4, over 15 cycles, the Pt-containing cells showed a higher initial utilization and improved stability in comparison to the baseline cell. Other nanocatalyst (Pd, Ni, and Co) cells had higher initial utilization and closely similar performance in comparison to the baseline cell. The table in FIG. 11 summarizes early cycle performance of the new structure Li—S cathode (first configuration) in comparison to baseline cathodes. FIG. 5(a) shows the cell performance for a Pt-containing Li—S cell and a baseline cell with sulfur loading of 2.50 mg/cm² charged at C/10 and discharged at C/5 over 100 cycles. The new structure Li—S cathode showed a high initial discharge capacity of 1538 mAh/g compared to a capacity of 1146 mAh/g for the baseline cathode. The new structure Li—S cathode showed a capacity drop of 7.5% in cycle 2 while the baseline Li—S cathode showed a 43% drop in capacity. The new structure Li—S cathode cells stabilized in 10 cycles at 1400 mAh/g average capacity whereas baseline Li—S cathode cells showed a continuous drop until stabilizing at a capacity of 530 mAh/g at cycle 30.

After 100 cycles of charge/discharge, the new structure Li—S cathode had a 13% drop in capacity while the baseline Li—S cathode showed a 53% drop in capacity. FIG. 5(b) shows a comparison of high sulfur loading (5.0 mg/cm²) cells. The Pt-containing cells showed 37% improved retention over 100 cycles in comparison to baseline cells. FIG. 5(c) shows results for cells with sulfur loading of 3.40 mg/cm² cycled at higher C-rate to examine the high-rate capability of the new structure cathode (cells charged at C/3 and discharged at C/2) over 200 cycles. The Pt-containing new structure cathode showed 27% improvement in capacity retention over 200 cycles in comparison to the baseline cathode.

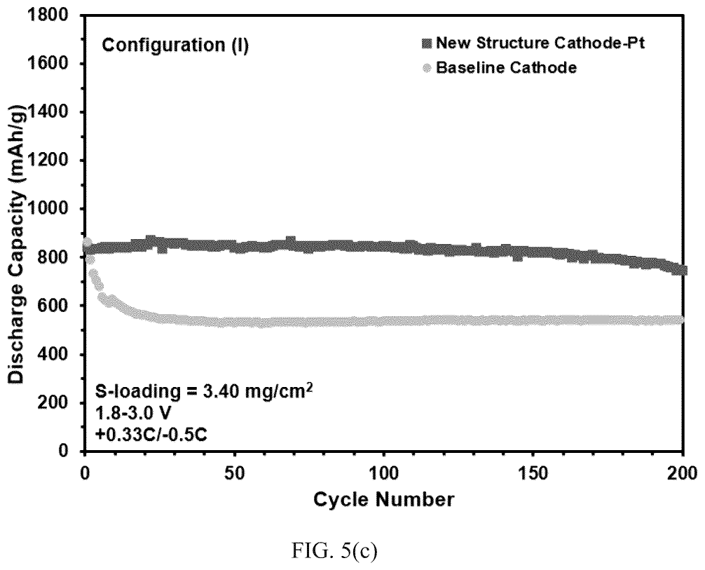

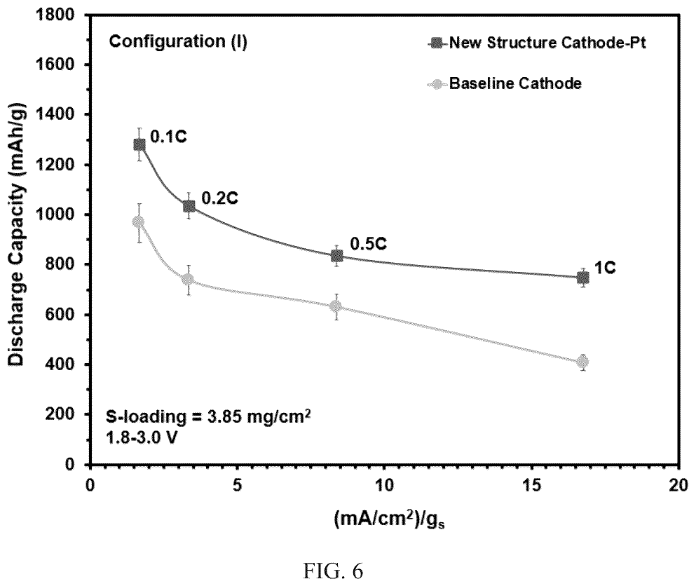

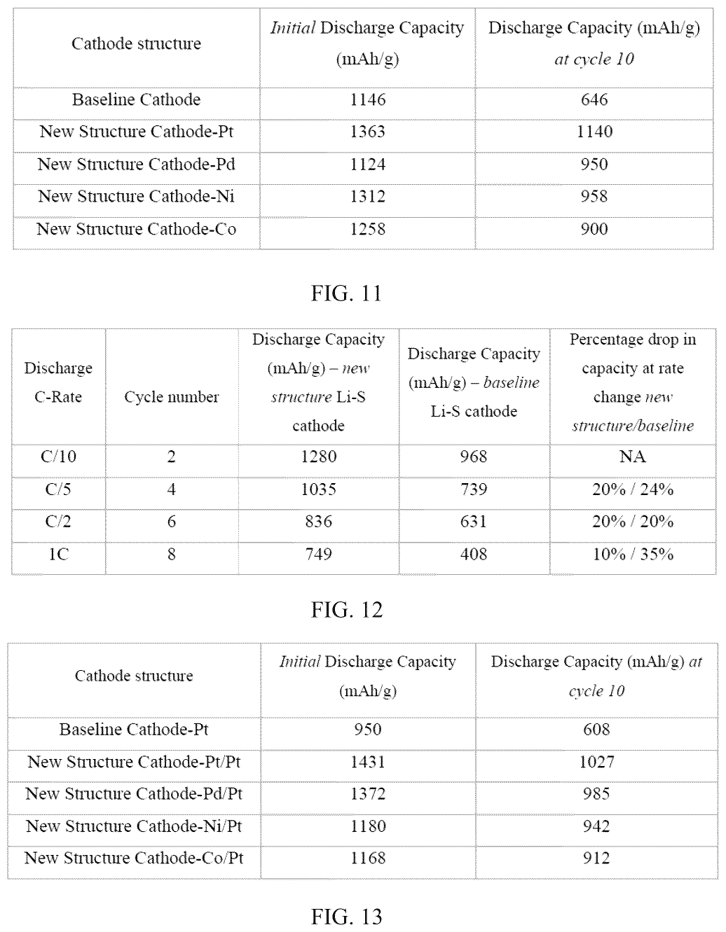

The rate capability of the Pt-containing new structure Li—S cathode (first configuration) was tested against the baseline cathode at different discharge C-rates (e.g., C/10, C/5, C/2, and 1C). Following an initial activation cycle at C/10, the cells were tested for two cycles at each rate. The rate capability data are reported for the cycle with the higher capacity. FIG. 6 shows the discharge capacity (in mAh/g) of the new structure Li—S and baseline cathode (in mAh/g) at different discharge rates. The table in FIG. 12 shows the significantly improved rate capability of the new structure Li—S cathode when the discharge C-rate was doubled (e.g., C/2 to 1C).

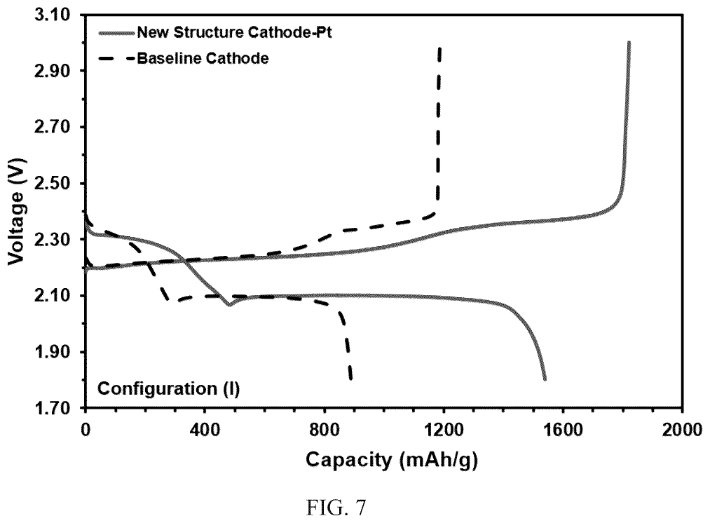

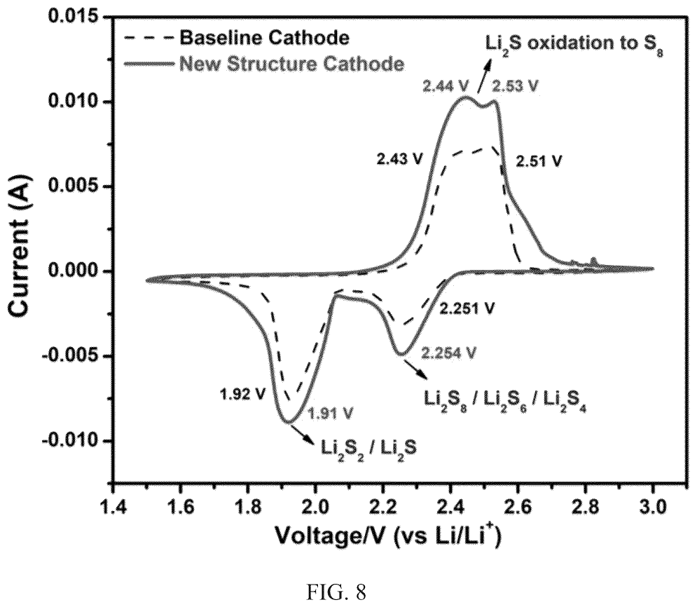

Voltage profiles of the initial cycle for both the new structure and baseline cathodes are shown in FIG. 7. The discharge voltage profile for the baseline and new structure cathodes showed an initial discharge capacity of 890 mAh/g and 1538 mAh/g, respectively. The improved initial cycle capacity can be seen in the higher capacity corresponds to the higher polysulfides (Li₂S₈ and Li₂S₆) reduction plateau (at 2.30 V). The improvement can also be noticed in the extended lower voltage plateau (at 2.10 V) of the new structure cathode, which has a significant contribution to the overall discharge capacity in comparison to the baseline cathode. Further electrochemical testing using cyclic voltammetry (at a scan rate of 0.1 mV/sec) shows (FIG. 8) higher amplitude reduction/oxidation peaks for the new structure cathode in comparison to the baseline Li—S cathode, which is an indication of improved reaction kinetics due to the enhanced catalytic activity of the new structure cathode.

### Example 6: Using the New Structure Li—S Cathode in Li—S Batteries (Second Configuration)

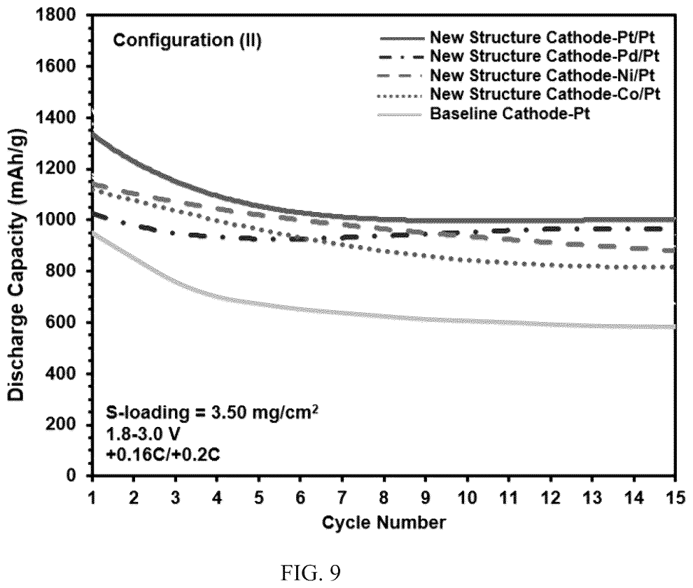

Similar to Example 5, coin cells CR2032 were assembled in an argon-filled glove box using a baseline or a new structure Li—S cathode (based on the second configuration) with a sulfur loading of 3.50 mg/cm², a polypropylene separator (Celgard), and a pre-cut Li disc. The electro-catalyzing and polysulfide trapping layer contains Pt, Pd, Co, and Ni (e.g., 1 wt % Pd of CNT) as the electrocatalyst while the sulfur-rich layer contained Pt metal (e.g., 1 wt % Pt of CNT). The new structure Li—S cathodes can be referred to as “new structure cathode-M/Pt” (where M=Pt, Pd, Ni, or Co). Assembled cells were crimped under pressure of 90 psi using an argon gas-driven coin cell crimper. Assembled cells were rested and tested at different C-rates (e.g., charged at C/6 and discharged at C/5) in the voltage window of 1.8 V-3.0 V. FIG. 9 shows the cell performance over 15 cycles presented in discharge capacity (in mAh/g) of the new structure Li—S cathodes with different catalysts (e.g., Pt, Pd, Ni, Co) in comparison to the baseline cathode that contained Pt in the sulfur-rich layer only. Referring to FIG. 9, as with FIG. 4 all new structure cathodes (of the second configuration) show higher sulfur utilization (initial discharge capacity) and improved capacity retention in comparison to the baseline cathode-Pt. Additionally, all new structure Li—S cathodes maintain higher capacity retention in subsequent cycles. The Pt/Pt cathodes demonstrated the highest capacity in 15 cycles followed by Pd/Pt and Ni/Pt while Co/Pt showed slightly lower capacity in comparison to all new structure cathodes of the second configuration. The table in FIG. 13 summarizes the initial discharge capacity (in mAh/g) as well as discharge capacity of cycle 15 for new structure cathodes having the second configuration in comparison to the baseline cathode-Pt.

It should be understood that the examples and embodiments described herein are for illustrative purposes only and that various modifications or changes in light thereof will be suggested to persons skilled in the art and are to be included within the spirit and purview of this application.

All patents, patent applications, provisional applications, and publications referred to or cited herein are incorporated by reference in their entirety, including all figures and tables, to the extent they are not inconsistent with the explicit teachings of this specification.

What is claimed is:

1. A positive electrode for a lithium-sulfur (Li—S) battery, the positive electrode comprising:
sulfur-rich layers comprising at least one first nanocatalyst; and
electro-catalyzing and polysulfide-trapping layers comprising at least one second nanocatalyst,
the sulfur-rich layers being merged and interlocked together with the electro-catalyzing and poly sulfide trapping layers in a graded structure.

2. The positive electrode according to claim 1, the at least one first nanocatalyst comprising a metal.

3. The positive electrode according to claim 1, the at least one second nanocatalyst comprising a metal.

4. The positive electrode according to claim 1, the at least one first nanocatalyst comprising at least one of nickel, cobalt, platinum, palladium, ruthenium, iridium, rhodium, silver, gold, nickel oxide, cobalt oxide, platinum oxide, palladium oxide, ruthenium oxide, iridium oxide, rhodium oxide, silver oxide, gold oxide, nickel sulfide, cobalt sulfide, platinum sulfide, palladium sulfide, ruthenium sulfide, iridium sulfide, rhodium sulfide, silver sulfide, gold sulfide, nickel fluoride, cobalt fluoride, platinum fluoride, palladium fluoride, ruthenium fluoride, iridium fluoride, rhodium fluoride, silver fluoride, gold fluoride, nickel carbide, cobalt carbide, platinum carbide, palladium carbide, ruthenium carbide, iridium carbide, rhodium carbide, silver carbide, and gold carbide, and
the at least one second nanocatalyst comprising at least one of nickel, cobalt, platinum, palladium, ruthenium, iridium, rhodium, silver, gold, nickel oxide, cobalt oxide, platinum oxide, palladium oxide, ruthenium oxide, iridium oxide, rhodium oxide, silver oxide, gold oxide, nickel sulfide, cobalt sulfide, platinum sulfide, palladium sulfide, ruthenium sulfide, iridium sulfide, rhodium sulfide, silver sulfide, gold sulfide, nickel fluoride, cobalt fluoride, platinum fluoride, palladium fluoride, ruthenium fluoride, iridium fluoride, rhodium fluoride, silver fluoride, gold fluoride, nickel carbide, cobalt carbide, platinum carbide, palladium carbide, ruthenium carbide, iridium carbide, rhodium carbide, silver carbide, and gold carbide.

5. The positive electrode according to claim 1, the positive electrode having sulfur distributed substantially uniformly across the graded structure.

6. The positive electrode according to claim 1, the sulfur-rich layers comprising conductive carbon, and
the electro-catalyzing and polysulfide-trapping layers comprising conductive carbon,

7. The positive electrode according to claim 6, the conductive carbon of the sulfur-rich layers being carbon nanotubes, graphene, fullerene, or graphitized carbon, and
the conductive carbon of the electro-catalyzing and polysulfide-trapping layers being carbon nanotubes, graphene, fullerene, or graphitized carbon.

8. An Li—S battery, comprising:
a current collector;
the positive electrode according to claim 1 disposed on and in direct physical contact with the current collector;
a separator disposed on and in direct physical contact with a first surface of the positive electrode, the first surface of the positive electrode being opposite from a second surface of the positive electrode with which the current collector is in direct physical contact; and
a lithium anode on the separator.

9. The Li—S battery according to claim 8, further comprising:
a first spacer below the current collector;
a spring below the first spacer;
a bottom cap below the spring;
a second spacer on the lithium anode; and
a top cap on the second spacer.

10. A method of fabricating a positive electrode, the method comprising:
preparing a composite mixture of a polymeric binder and a carbon-containing material, the carbon-containing material comprising conductive carbon and a metal nanocatalyst present at a predetermined weight percentage;
adding a first organic solvent to the composite mixture to give a first solution;
performing vacuum filtration on the first solvent to give a graded porous film; and
drying the graded porous film to give the positive electrode,
the positive electrode comprising sulfur-rich layers merged and interlocked together with electro-catalyzing and polysulfide trapping layers in a graded structure.

11. The method according to claim 10, the metal nanocatalyst comprising at least one of nickel, cobalt, platinum, palladium, ruthenium, iridium, rhodium, silver, gold, nickel oxide, cobalt oxide, platinum oxide, palladium oxide, ruthenium oxide, iridium oxide, rhodium oxide, silver oxide, gold oxide, nickel sulfide, cobalt sulfide, platinum sulfide, palladium sulfide, ruthenium sulfide, iridium sulfide, rhodium sulfide, silver sulfide, gold sulfide, nickel fluoride, cobalt fluoride, platinum fluoride, palladium fluoride, ruthenium fluoride, iridium fluoride, rhodium fluoride, silver fluoride, gold fluoride, nickel carbide, cobalt carbide, platinum carbide, palladium carbide, ruthenium carbide, iridium carbide, rhodium carbide, silver carbide, and gold carbide.

12. The method according to claim 10, the predetermined weight percentage being in a range of from 0.1 wt % to 10 wt %.

13. The method according to claim 10, the carbon-containing material further comprising sulfur.

14. The method according to claim 10, the preparing of the composite mixture comprising:
dissolving the polymeric binder in a second organic solvent to give a second solution;
gradually adding the second solution to a dry powder mixture of the carbon-containing material to give a third solution; and
grinding the third solution to evaporate the second organic solvent and give the composite mixture.

15. The method according to claim 10, the drying of the graded porous film comprising drying the graded porous film at a temperature in a range of from 40° C. to 100° C. for a period of time in a range of from 10 hours to 15 hours.

16. The method according to claim 10, further comprising preparing the carbon-containing material prior to preparing the composite mixture, and
the preparing of the carbon-containing material comprising:
preparing a first mixture of the conductive carbon and a salt of the metal nanocatalyst;
adding deionized water to the first mixture to give a second mixture;
bath sonicating the second mixture;
drying the second mixture after the bath sonicating of the second mixture;
grinding the second mixture after the drying of the second mixture;
oxidizing the second mixture in a furnace after grinding the second mixture to give an oxidized second mixture;
allowing the oxidized second mixture to cool down;
reducing the oxidized second mixture, after allowing the oxidized second mixture to cool down, by providing a gas flow comprising hydrogen to the oxidized second mixture to provide a reduced second mixture;
allowing the reduced second mixture to cool down; and
grinding the reduced second mixture, after allowing the second mixture to cool down, to give a dry powder mixture of the carbon-containing material.

17. The method according to claim 16, the metal nanocatalyst comprising at least one of nickel, cobalt, platinum, palladium, ruthenium, iridium, rhodium, silver, gold, nickel oxide, cobalt oxide, platinum oxide, palladium oxide, ruthenium oxide, iridium oxide, rhodium oxide, silver oxide, gold oxide, nickel sulfide, cobalt sulfide, platinum sulfide, palladium sulfide, ruthenium sulfide, iridium sulfide, rhodium sulfide, silver sulfide, gold sulfide, nickel fluoride, cobalt fluoride, platinum fluoride, palladium fluoride, ruthenium fluoride, iridium fluoride, rhodium fluoride, silver fluoride, gold fluoride, nickel carbide, cobalt carbide, platinum carbide, palladium carbide, ruthenium carbide, iridium carbide, rhodium carbide, silver carbide, and gold carbide, and
the predetermined weight percentage being in a range of from 1 wt % to 5 wt %.

18. The method according to claim 16, the oxidizing of the second mixture comprising oxidizing the second mixture in the furnace at a temperature of about 350° C. for a period of time of about 2 hours, and
the reducing of the second mixture comprising providing the gas flow at a temperature of about 400° C. for a period of time of about 2 hours,
the gas flow further comprising argon.

19. A method of fabricating a Li—S battery, the method comprising:
performing the method according to claim 10 to fabricate a positive electrode;
disposing the positive electrode on and in direct physical contact with a current collector;
disposing the positive electrode on and in direct physical contact with a separator; and
disposing a lithium anode on the separator.

20. A method of fabricating a positive electrode, the method comprising:
preparing a composite mixture of a polymeric binder and a carbon-containing material, the carbon-containing material comprising conductive carbon, sulfur, and a metal nanocatalyst present at a predetermined weight percentage;
adding a first organic solvent to the composite mixture to give a first solution;
performing vacuum filtration on the first solvent to give a graded porous film; and
drying the graded porous film to give the positive electrode,
the positive electrode comprising sulfur-rich layers merged and interlocked together with electro-catalyzing and polysulfide trapping layers in a graded structure,
the metal nanocatalyst comprising at least one of nickel, cobalt, platinum, palladium, ruthenium, iridium, rhodium, silver, gold, nickel oxide, cobalt oxide, platinum oxide, palladium oxide, ruthenium oxide, iridium oxide, rhodium oxide, silver oxide, gold oxide, nickel sulfide, cobalt sulfide, platinum sulfide, palladium sulfide, ruthenium sulfide, iridium sulfide, rhodium sulfide, silver sulfide, gold sulfide, nickel fluoride, cobalt fluoride, platinum fluoride, palladium fluoride, ruthenium fluoride, iridium fluoride, rhodium fluoride, silver fluoride, gold fluoride, nickel carbide, cobalt carbide, platinum carbide, palladium carbide, ruthenium carbide, iridium carbide, rhodium carbide, silver carbide, and gold carbide,
the predetermined weight percentage being in a range of from 1 wt % to 5 wt %,
the drying of the graded porous film comprising drying the graded porous film at a temperature in a range of from 40° C. to 60° C. for a period of time in a range of from 10 hours to hours,
the preparing of the composite mixture comprising:
dissolving the polymeric binder in a second organic solvent to give a second solution;
gradually adding the second solution to a dry powder mixture of the carbon-containing material to give a third solution; and
grinding the third solution to evaporate the second organic solvent and give the composite mixture,
the method further comprising preparing the carbon-containing material prior to preparing the composite mixture, and
the preparing of the carbon-containing material comprising:
preparing a first mixture of the conductive carbon and a salt of the metal nanocatalyst;
adding deionized water to the first mixture to give a second mixture;
bath sonicating the second mixture;
drying the second mixture after the bath sonicating of the second mixture;
grinding the second mixture after the drying of the second mixture;
oxidizing the second mixture in a furnace after grinding the second mixture to give an oxidized second mixture;
allowing the oxidized second mixture to cool down;
reducing the oxidized second mixture, after allowing the oxidized second mixture to cool down, by providing a gas flow comprising hydrogen to the oxidized second mixture to provide a reduced second mixture;
allowing the reduced second mixture to cool down; and
grinding the reduced second mixture, after allowing the second mixture to cool down, to give the dry powder mixture of the carbon-containing material.
